(19) United States
(12) Patent Application Publication
(10) Pub. No.: US 2016/0019528 A1
(43) Pub. Date: Jan. 21, 2016

(54) SYSTEM AND METHOD FOR PAYMENT AND SETTLEMENT USING BARCODE

(71) Applicant: Pa-Ul HONG, (US)

(72) Inventor: Pa-Ul HONG, Seoul (KR)

(21) Appl. No.: 14/773,639

(22) PCT Filed: Feb. 28, 2014
(86) PCT No.: PCT/KR2014/001669

§ 371 Date: Sep. 8, 2015

(30) Foreign Application Priority Data
Mar. 6, 2013 (KR) 10-2013-0023991

(51) Int. Cl. G06Q 20/32; G06Q 20/40

(52) U.S. Cl. CPC G06Q 20/3274; G06Q 20/405

(57) ABSTRACT

A system and method for payment and settlement for an electronic transaction in which a user may generate a one-time barcode representing an intention to pay the amount of money that the user may spend on an electronic transaction, and may perform settlement online and offline by using the barcode within the amount of money of the barcode. When a user intends to purchase goods online and offline, the user generates a barcode, representing an intention to pay the amount of money corresponding to the price of the goods, in a smart device prior to purchasing the goods, and then the user can perform settlement using only the barcode, within the amount of money encoded in the barcode at the time of generating the barcode, at online and offline affiliated stores that can read the barcode in the smart device.

### BACKGROUND

The present invention generally relates to a system and method for payment and settlement according to electronic commerce and, more particularly, to a system and method for payment and settlement using a barcode, in which a user can generate a one-time barcode representing an intention to pay the amount of money to be spent for an electronic transaction and can perform online or offline settlement within the amount of money encoded in the barcode by using the barcode.

According to the recent rapid development of wire-wireless internet communication technologies, e-commerce has become popular, and electronic financial transactions for e-commerce have also become popular and diversified.

Examples of electronic financial transactions include card payment as a basic form, internet banking, cyber banking (home banking), mobile banking, and the like.

As e-commerce and electronic financial transactions using a wire-wireless internet network have become popular and diversified, various phishing crimes using e-commerce and electronic financial transactions have been increasing.

Methods of minimally exposing personal information and settlement information have been mainly used as methods for preventing these phishing crimes.

Also, electronic transactions and electronic financial transactions using barcodes have been recently activated. A mobile coupon method, a barcode settlement method, and the like have been applied to the electronic transactions and electronic financial transactions using barcodes, wherein the mobile coupon method includes: performing an electronic financial transaction relating to the predetermined amount of money and a product with a price corresponding to the predetermined amount of money; and generating and providing a barcode corresponding to the predetermined amount of money and the product, and a barcode settlement method includes: generating a barcode mapped with various pieces of settlement information resulting from various settlement means; and using a barcode instead of other settlement means, and the like.

However, the mobile coupon method is problematic in that an electronic financial transaction for purchasing a mobile coupon is still exposed to phishing crimes because settlement information should be input as in a conventional method. The barcode settlement method is problematic in that it lacks security because settlement can be performed even when a barcode is stolen by a third party, despite the fact that there is no concern about phishing of personal information and settlement information.

### SUMMARY OF THE INVENTION

Accordingly, an object of the present invention is to provide a system and method for payment and settlement using a barcode, in which a user can generate a one-time barcode representing an intention to pay an amount to be used in an electronic transaction and can perform settlement online or offline within the amount of money encoded in the barcode.

In order to accomplish the above object(s), the present invention provides a system for payment and settlement using a barcode, the system including: a user smart device adapted to receive settlement amount information input via a settlement request means and to transmit a settlement request signal including the settlement amount information, user identification information and device identification information, the user smart device receiving a barcode in response to the settlement request signal and storing and displaying the received barcode; an affiliated store smart device adapted to scan the barcode from the user smart device and to transmit a settlement approval requesting signal including information about the scanned barcode, affiliated store identification information and purchase amount information, the affiliated store smart device receiving information about details of settlement including the settlement amount information of the barcode and the purchase amount information of a purchase product in response to the settlement approval request signal and storing and displaying the received information; and a payment and settlement management server adapted to generate and register the barcode including the settlement amount information, user identification information, and device identification information included in the settlement request signal when receiving the settlement approval request signal from the user smart device and to transmit the generated barcode to the user smart device, the payment and settlement management server inspecting whether or not a barcode corresponding to the barcode included in the settlement approval request signal is registered when receiving the settlement approval request signal from the user smart device, and transmitting the details of settlement to the affiliated store smart device when a corresponsive barcode is registered.

The payment and settlement management server may check whether or not a user has ability to pay a settlement amount included in the settlement request signal via a stored settlement means mapped with the user identification information when receiving the settlement request signal, thereby generating the barcode when the user has the ability to pay the settlement amount.

The payment and settlement management server may transmit information about the details of settlement to the affiliated store smart device and may then delete the registered barcode, thereby transmitting a barcode deletion requesting signal to the user smart device and the affiliated store smart device so that the barcode can be deleted.

The payment and settlement management server may register information about a time at which the barcode is generated when registering the barcode, and may automatically delete the barcode when the barcode issued to the user smart device is not used by a predetermined period from the time at which the barcode is generated, thereby transmitting a barcode deletion requesting signal to the user smart device and the affiliated store smart device so that the barcode can be deleted.

The affiliated store smart device may display the details of settlement and may then transmit a purchase amount payment requesting signal including the affiliated store identification information and the purchase amount and barcode information to the payment and settlement management server when a payment request for the purchase amount is generated; the user smart device may display an approval confirmation signal received from the payment and settlement management server and may generate an approval signal when an approval order is input by the user, thereby transmitting the generated approval signal to the payment and settlement management server; and the payment and settlement management server may transmit the approval confirmation signal resulting from a request for payment and settlement to the user smart device corresponding to the device identification information included in the barcode information when receiving the settlement request signal, the payment and settlement management server being connected to a financial server unit based on pre-registered settlement information regarding the user of the user identification information when receiving an approval signal from the user smart device in response to the approval confirmation signal so that payment and settlement can be performed.

The user smart device may further receive information about a password input from the user and may transmit the information about the password by including the information in the settlement request signal; and the payment and settlement management server may map the password with the barcode when generating and registering the barcode by receiving the settlement request signal, the payment and settlement management server being connected to the financial server unit based on pre-registered settlement information regarding the user of the user identification information when a password for the barcode input from the affiliated store smart device after providing the details of settlement resulting from receiving the settlement approval requesting signal from the affiliated store smart device is consistent with the barcode mapped with the barcode, so that payment and settlement can be performed.

The payment and settlement management server may delete the registered barcode after processing the payment and settlement and may transmit a barcode deletion requesting signal to the user smart device and the affiliated store smart device so that the barcode can be deleted.

The payment and settlement management server may register information about a time at which the barcode is generated when registering the barcode, and may automatically delete the barcode when the barcode issued to the user smart device is not used by a predetermined period from the time at which the barcode is generated, the payment and settlement management server transmitting the barcode deletion requesting signal to the user smart device and the affiliated store smart device so that the barcode can be deleted.

The present invention provides a method for payment and settlement using a barcode, the method including: receiving and storing, by a payment and settlement management server, user identification information and payment information of a user, and an affiliated store identification information and settlement information of an affiliated store, thereby registering the user and the affiliated store as members for payment and settlement services using a barcode; transmitting, by a user smart device, a settlement request signal including settlement amount information, user identification information and device identification information to the payment and settlement management server, thereby requesting settlement; generating and registering, by the payment and settlement management server, a barcode including settlement amount information, user identification information and device identification information included in the settlement request signal when receiving the settlement request signal from the user smart device, and transmitting the barcode to the user smart device, thereby providing the barcode; scanning, by an affiliated store smart device, the barcode displayed on the user smart device, and transmitting a settlement approval requesting signal including the scanned barcode, affiliated store identification information, and purchase amount information to the payment and settlement management server, thereby requesting a settlement approval; and inspecting, by the payment and settlement management server, whether or not the same barcode as the barcode included in the settlement approval signal is registered, and transmitting details of settlement to the affiliated store smart device when the barcode is registered.

The providing the barcode may include: checking, by the payment and settlement management server, whether or not a user has to pay a settlement amount included in the settlement request signal via a stored settlement means mapped with the user identification information when receiving the settlement request signal; and generating the barcode when it is determined that the user has the ability to pay the settlement amount.

The method may further include: deleting, by the payment and settlement management server, the barcode after providing the details of settlement; and transmitting a barcode deletion requesting signal to the user smart device and the affiliated store smart device so that the barcode can be deleted.

The method may further include: registering, by the payment and settlement management server, information about a time at which the barcode is generated when receiving the barcode; automatically deleting the barcode when the barcode issued to the user smart device is not used by a predetermined period from the time at which the barcode is generated; and transmitting a barcode deletion requesting signal to the user smart device and the affiliated store smart device so that the barcode can be deleted.

The method may further include: transmitting, by the affiliated store smart device, a purchase amount payment requesting signal including the affiliated store identification information, and purchase amount and barcode information to the payment and settlement management server when the affiliated store smart device displays the details of the settlement after the providing the details of the settlement, and a request for payment and settlement of the purchase amount is then generated; transmitting, by the payment and settlement management server, an approval confirmation signal resulting from the request for the payment and settlement to the user smart device corresponding to the device identification information included in the barcode information when receiving the settlement request signal, thereby confirming a payment and settlement approval; displaying, by the user smart device, the approval confirmation signal received from the payment and settlement management server and generating an approval signal when an approval order is input by the user, thereby transmitting the approval signal to the payment and settlement management server; and connecting, by the payment and settlement management server, to a financial server unit based on pre-registered settlement information regarding the user of the user identification information when receiving the approval signal from the user smart device in response to the approval confirmation signal so that payment and settlement can be performed.

The method may further include: transmitting, by the user smart device, a password input by the user during requesting of the settlement; mapping, by the payment and settlement server, the password with the barcode when generating and registering the barcode by receiving the settlement request signal; and connecting, by the payment and settlement server, to a financial server unit based on pre-registered settlement information regarding the user of the user identification information when a password for the barcode is input from the affiliated store smart device after the providing the details of the settlement, and the password is consistent with the password mapped with the barcode, so that payment and settlement can be performed.

The method may further include: deleting, by the payment and settlement server, the registered barcode after processing the payment and settlement; and transmitting a barcode deletion requesting signal to the user smart device and the affiliated store smart device so that the one-time barcode can be deleted.

The method may further include: registering, by the payment and settlement management server, information about a time at which the barcode is generated when registering the barcode during the providing the barcode; automatically deleting, by the payment and settlement management server, the barcode when the barcode issued to the user smart device is not used by a predetermined period from the time at which the barcode is generated; and transmitting the barcode deletion requesting signal to the user smart device and the affiliated store smart device so that the barcode can be deleted.

According to the present invention, when a user intends to purchase a product online and offline, the user can generate a barcode, representing an intention to pay the amount of money corresponding to the price of the product, in a smart device prior to purchasing the product, and then the user can perform settlement using only the barcode, within the amount of money encoded in the barcode, at online and offline affiliated stores that can read the barcode, so that personal and settlement information of the user do not need to be exposed in actual online and offline stores, thereby improving security.

Also, the barcode of the present invention is generated as a one-time barcode using a random number so that the barcode can be prevented from being stolen by a third party, and security can be improved.

Also, the barcode of the present invention can be used only one time within a predetermined period so that the barcode can be prevented from being stolen by a third party, and security can be improved.

Also, according to the present invention, when a barcode for a predetermined amount of money is generated, the barcode is generated only when the user who requests to generate the barcode has an ability to pay the amount of money so that reliability concerning the barcode can be improved.

Also, according to the present invention, user confirmation is further performed once again when payment and settlement for actually paying the amount of money is performed, or authentication based on a password is further performed so that security can be improved.

### BRIEF DESCRIPTION OF DRAWINGS

FIG. 1 is a view showing a configuration of a system for payment and settlement using a barcode according to the present invention;

FIG. 2 is a view showing a configuration of a payment and settlement management server of the system for payment and settlement using a barcode according to the present invention;

FIG. 3 is a flow chart showing a method for payment and settlement using a barcode according to a first embodiment of the present invention; and

FIG. 4 a flow chart showing a method for payment and settlement using a barcode according to a second embodiment of the present invention.

### DETAILED DESCRIPTION OF THE INVENTION

The configurations and operations of a system for payment and settlement using a barcode according to the present invention, and a method for payment and settlement using a barcode performed through the system for payment and settlement will be hereinafter described with reference to the accompanying drawings.

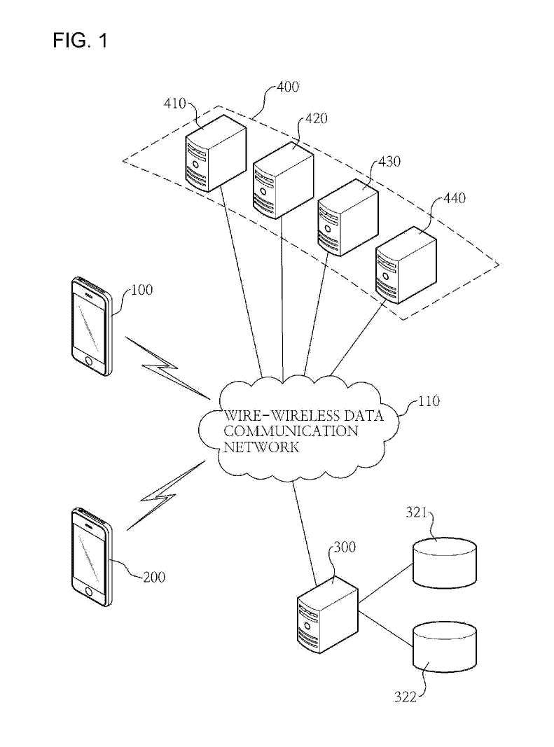

FIG. 1 is a view showing a configuration of a system for payment and settlement using a barcode according to the present invention.

Referring to FIG. 1, the system for payment and settlement according to the present invention may include a user smart device 100, an affiliated store smart device 200, and a payment and settlement management server 300. In addition, the system may further include a financial server unit 400 intended for performing payment.

A wire-wireless data communication network 110 may enable data communication to be performed among financial server units 400 including the user smart device 100, the affiliated store smart device 200, the payment and settlement management server 300, a PG server 410, a VAN server 420, a bank server 430, a card company server 440, and the like by being connecting to a WiFi network, an internet network (WAN), a 3G network, an LTE network, and the like.

The user smart device 100 may be a smart phone, a smart pad, a tablet PC, and the like and may be connected to the wire-wireless data communication network 110 by wireless, thereby conducting data communication with the payment and settlement management server 300. The user smart device 100 according to the present invention receives user identification information and settlement amount information for performing payment and settlement using the barcode, and provides a settlement request signal including the user identification information, settlement information and device identification of the user smart device 100 to the payment and settlement management server 300, the user smart device receiving the barcode corresponding to the settlement request signal and storing and displaying the received barcode. The settlement request signal may further include location information of the smart device. In general, the barcode may be a one-dimensional barcode, a two-dimensional barcode, and the like, wherein the two-dimensional barcode may be a QR code and the like.

The affiliated store smart device 200 may be a device, such as a smart phone, a smart pad, a tablet PC, a smart TV, and the like, having a means that can scan a camera and a barcode and may be connected to the wire-wireless data communication network 110, thereby performing data communication with the payment and settlement management server 300. The affiliated store smart device 200 according to the present invention may scan a barcode indicated in the user smart device 100 and may transmit a payment approval requesting signal including scanned barcode information, purchase amount information about a product, affiliated store identification information, and device identification information of the smart device 200 to the payment and settlement management server 300, thereby receiving information about the details of payment approval from the payment and settlement management server 300 by responding to the payment approval requesting signal and displaying the information.

The payment and settlement management server 300 receives and registers barcode payment service registration information input by an arbitrary user and a manager of an affiliate store and checks the user's payment ability for the amount included in the payment approval requesting signal based on pre-stored payment information by responding to the user's payment approval requesting signal when receiving the payment approval requesting signal from the user smart device 100 of the user registered in the payment service. Thus, when the user has the payment ability, the payment and settlement management server generates a disposable barcode and transmits the generated disposable barcode to the user smart device 100. The generated barcode is stored and managed in a payment and settlement database 321. However, even though the barcode may be transmitted to the user smart device 100 as described above, when the user inputs smart device identification information such as a telephone number and the like of a smart device of a third party through the user smart device 100, the barcode may be also transmitted to a smart device including the smart device identification information.

Furthermore, the payment and settlement management server checks whether or not a barcode corresponding to the barcode included in the payment approval requesting signal is stored in the payment and settlement database 321 when receiving the payment approval requesting signal from the affiliated store smart device 200 that has been registered. When the corresponding barcode is present, the payment and settlement management server 300 provides payment information for the payment approval requesting signal to the affiliated store smart device 200. The payment information includes information about an amount paid by the user via the user smart device 100, payment ability information showing the user's payment ability concerning the purchase amount of a purchased product, and the like.

When transmitting the payment information, and thereafter, receiving a payment processing requesting signal from the affiliated store smart device 200, the payment and settlement management server 300 obtains approval from the user via the user smart device 100, and is then connected to the financial server unit 400 to perform substantial payment processing via a payment means registered by the user.

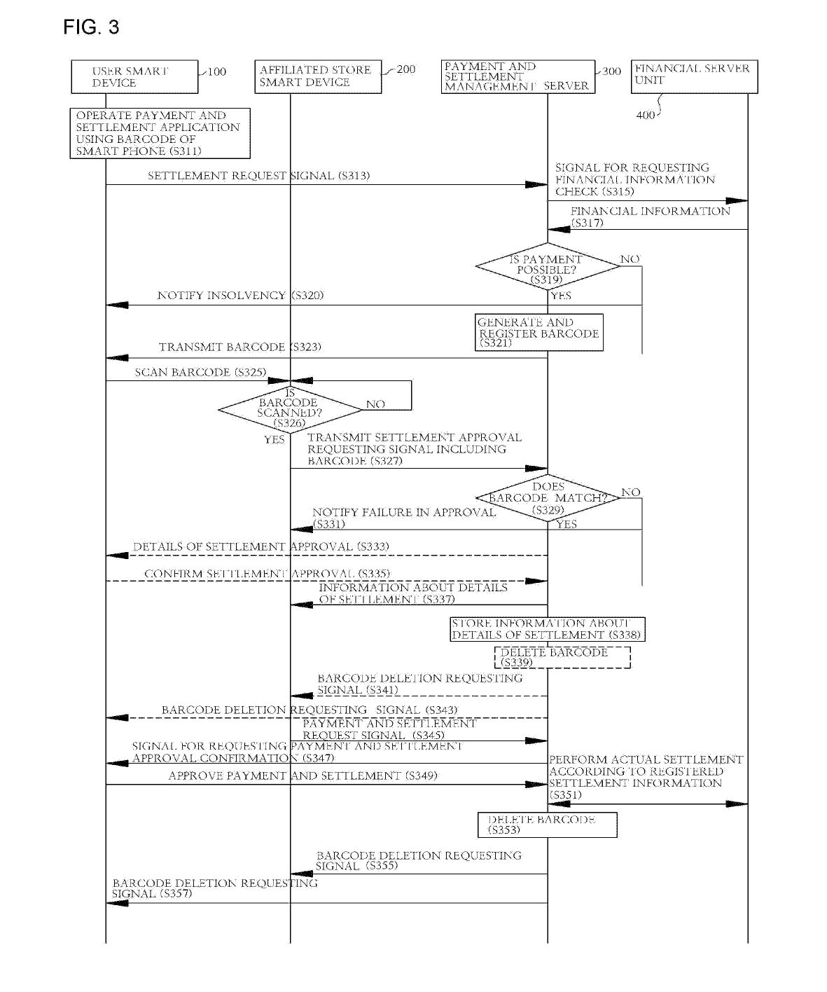

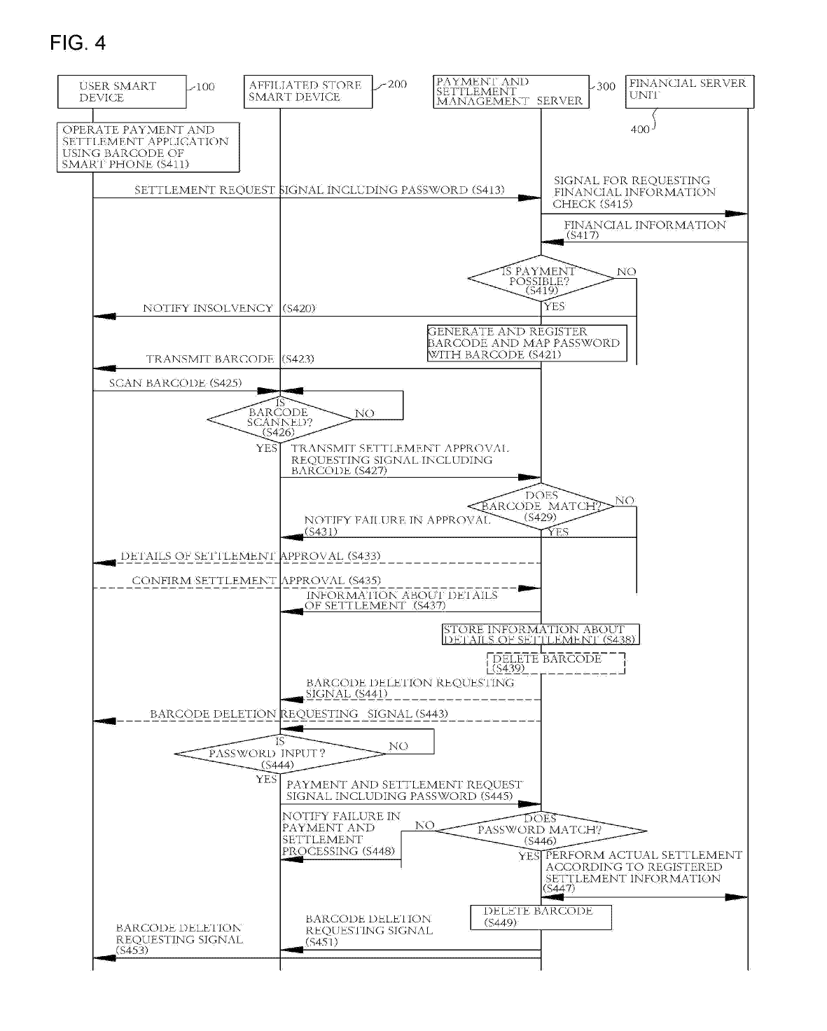

The payment and settlement management server 300 may receive, from the user smart device 100, information as to whether or not the user actually performs payment processing upon the substantial payment processing, or may be configured such that a user is required to input a password via the affiliated store smart device 200 upon requesting the payment so that authentication can be performed, and actual payment and settlement processing can be then performed. This configuration will be described in detail with reference to FIGS. 3 and 4 that will be described later.

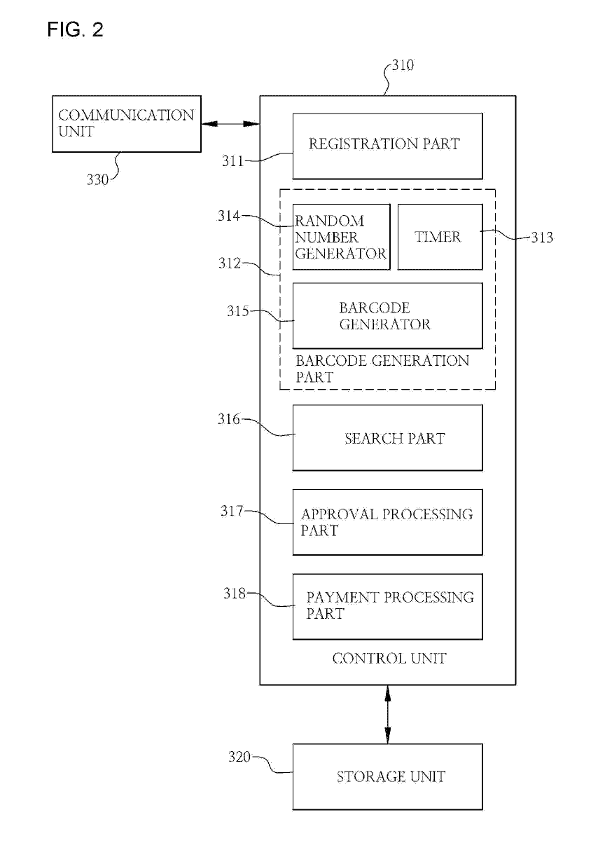

FIG. 2 is a view illustrating a configuration of the payment and settlement management server of the system for payment and settlement system using a barcode according to the present invention. The detailed configuration and operation of the payment and settlement management server will be hereinafter described with reference to FIG. 2.

The payment and settlement management server 300 according to the present invention includes a control unit 310, a storage unit 320, and a communication unit 330.

The control unit 310 controls a whole operation of the payment and settlement management server 300 intended for providing payment and settlement services using a barcode. The detailed configuration and operation of the control unit 310 will be hereinafter described.

The storage unit 320 includes: a program storage area adapted to store a control program for providing payment and settlement services using a barcode according to the present invention; a temporary area adapted to temporarily store data generated during executing the control program; and a data area adapted to store registration information including payment information according to each user and affiliated store the payment and settlement database 321, the data area being adapted to store the payment and settlement database 321 in which barcode information about an activated barcode generated according to the present invention is stored and registered, a database for the details of payment and settlement 322 in which information about the details of the payment and settlement is stored and managed according to each user and affiliated store, and the like.

The payment and settlement database 321 is mapped with the barcode information about the activated barcode so that information about a time at which the barcode is generated can be stored, and stores information about a user's password, and the like according to the second embodiment of the present invention.

The communication unit 330 is connected to the wire-wireless data communication network 110, thereby conducting data communication with the user smart device 100, the affiliated store smart device 200 and the financial server unit 400 connected to the wire-wireless data communication network 110.

The configuration and operation of the control unit 310 will be hereinafter described in detail. The control unit 301 includes a registration part 311, a barcode generation part 312, a search part 316, an approval processing part 317, and a payment processing part 318.

The registration part 311 receives registration information for using payment and settlement services transmitted from the user smart device 100 and the affiliated store smart device 200 and stores the registration information in the payment and settlement database 321 of the storage unit 320. The registration information of each user includes user identification information and payment information, and the registration information of each affiliated store includes affiliated store identification information and payment information. These pieces of registration information may further include device identification information of a relevant smart device.

The barcode generation part 312 includes: a random number generator 314 adapted to generate a random number; and a barcode generator 315 adapted to obtain a random number generated from the random number generator 314 upon receiving a settlement request signal from a timer 313 calculating a current time and the user smart device 100, to obtain the current time calculated by the timer 313 as barcode generating time information, and to generate a barcode including a settlement amount included in the settlement request signal, a random number, and the like. The barcode may further include at least one piece of information of barcode identification information such as a unique identification number of the barcode, device identification information of the user smart device 100, and location information of the user smart device 100. The barcode identification information may be a serial number or a random number generated from the random number generator 314. Furthermore, in order to display the location information, the user smart device 100 should measure a location and should delivery the location information by including the location information in the settlement request signal.

The search part 316 is connected to the financial server unit 400 via the wire-wireless data communication network 100 and performs a search for balance and as to whether a payment service is available by using the financial server (a card server, a bank server, and the like) of the financial server unit corresponding to a payment means registered by the user of the user smart device 100 through the registration part when the settlement request signal is received, the search part 316 judging as to whether or not a settlement amount included in the settlement request signal can be paid according to the balance and the result as to whether or the payment service is available. For example, the search part 316 performs searching of the balance using a corresponding bank server of the financial server when the pre-registered settlement means is cash transfer and determines as to whether or not the payment can be performed by comparing the balance with the settlement amount of money. Thus, when the settlement means is a card, the search part searches a settlement limit and a currently used amount of money of a card company, and inspects whether or not the settlement amount included in the settlement request signal can be paid, thereby determining whether or not the settlement amount can be paid.

The approval processing part 317 compares the barcode included in the settlement approval request signal with barcodes registered in the payment and settlement database 321 of the storage unit 320 when the settlement approval request signal including the barcode is received from the affiliated store smart device 200, thereby checking whether or not there is a barcode corresponding to the barcode included in the settlement approval request signal. Thus, when there is a corresponding barcode, information about the details of settlement according to an approval is provided to the affiliated store smart device 200.

The payment processing part 318 enables substantial payment and settlement through the financial server corresponding to the user's settlement means pre-registered concerning the barcode approved by the approval processing part 317.

FIG. 3 is a flow chart showing a method for payment and settlement using a barcode according to the first embodiment of the present invention. The method for payment and settlement using a barcode will be described with reference to FIGS. 1 to 3.

First, in order to use a payment and settlement service using a barcode according to the present invention, a user should select a payment and settlement application using a smart phone barcode from the user smart device 100. When the payment and settlement application is selected, the user smart device 100 drives the selected payment and settlement application (S311). When the application is driven, the user smart device 100 may be in a state of being connected to the payment and settlement management server 300 using on pre-set user identification information via the payment and settlement application using a barcode

After the application has been driven, a settlement amount of money is input via the user smart device 100, and settlement is requested, then the user smart device 100 transmits a settlement request signal including a settlement amount of money, user identification information, device identification information of the user smart device 100 to the payment and settlement management server 300 (S313). At this time, the user smart device 100 may measure its location using a GPS module configured in the user smart device, or a network and may transmit the settlement request signal by including information about the measured location in the settlement request signal.

The payment and settlement management server 300 receiving the settlement request signal detects the user identification information from the settlement request signal and uploads settlement information including the user's settlement means (a card, a cash transfer, and the like) corresponding to the user identification information, and settlement means information (a card number, an account number, and the like), the payment and settlement management server transmitting a signal for requesting a financial information inquiry to a corresponding financial server of the financial server unit 400 (S315).

When the financial information is received in response to the signal for requesting the financial information inquiry (S317), the payment and settlement management server 300 analyzes financial information and determines as to whether or not the settlement amount of money included in the settlement request signal can be paid through the settlement means (S319).

As a result, when payment cannot be performed, the payment and settlement management server 300 notifies to the user smart device 100 that the amount cannot be paid (S320).

On the contrary, when payment can be performed, the payment and settlement management server 300 generates a barcode through the barcode generator 313 and registers the barcode in the payment and settlement database 321 of the storage unit 320 (S321).

After the generated barcode has been registered, the payment and settlement management server 300 transmits the registered barcode to the user smart device 100 (S323).

The barcode transmitted to the user smart device 100 may be stored in the user smart device 100 and may be displayed on a screen of the user smart device 100 via the payment and settlement application using a barcode, or a separate image display application.

The user may present the barcode stored and displayed in the user smart device 100 as described above when purchasing a product.

The affiliated store smart device 200 should also drive a payment and settlement application for an affiliated store and inspects whether or not the barcode is scanned when the barcode payment and settlement application is driven (S326).

At this time, when the user presents the barcode via the user smart device 100, the affiliated store smart device 200 will scan the barcode from the user smart device 100 (S325). The scanning may be performed by a barcode scanner connected to the affiliated store smart device 200 and may be performed by a camera of the affiliated store smart device 200.

When the barcode is scanned from the user smart device 100 (S326), the affiliated store smart device 200 transmits the settlement approval request signal including the scanned barcode and a purchase amount to the payment and settlement management server 300 (S327).

The payment and settlement management server 300 determines certification of the barcode based on whether or not a barcode corresponding to the barcode included in the settlement approval request signal is pre-registered in the payment and settlement database 321 of the storage unit 320 (S329).

As a result, when the certification of the barcode fails because there is no corresponding barcode in the payment and settlement database 321, the payment and settlement management server 300 notifies an approval failure to the affiliated store smart device 200 (S331), and when the certification of the barcode succeeds because there is a corresponding barcode, information about the details of settlement is transmitted to the affiliated store smart device 200 (S337). As described above, the information about the details of settlement includes information about an amount of money paid by the user of the user smart device 100, payment capability information showing whether or not the user has an ability to pay the purchase amount, and the like.

In the description above, the example in which when the approval of the barcode is achieved by the payment and settlement management server 300, the details of settlement are transmitted to the affiliated store smart device 200 that has been described. However, the payment and settlement management server 300 may transmit the details of settlement approval to the user smart device 100 when succeeding in the approval of the barcode (S333) and may receive a settlement approval confirmation signal for the details of the settlement approval (S335) and may then transmit information about the details of settlement to the affiliated store smart device 200 (S337).

When the settlement approval is completed, the payment and settlement management server 300 stores the information about the details of settlement in the database for the details of payment and settlement 322 of the storage unit 320 (S338). After storing the information about the details of settlement, the payment and settlement management server 300 may delete the barcode (the barcode used in settlement approval) registered in the payment and settlement database 321 (S339). This is because the barcode is a one-time barcode.

After deleting the barcode, the payment and settlement management server 300 transmits a barcode deletion requesting signal to the user smart device 100 and the affiliated store smart device 200 (S341, S343). Then, the user smart device 100 and the affiliated store smart device 200 will delete the barcode using the payment and settlement application using the barcode.

In the description above, the example in which the user expresses his or her intention to pay the corresponding amount of money only by inputting the settlement amount of money concerning the product purchased by the user has been described.

However, the user may perform substantial payment and settlement concerning a purchase amount of the product for the affiliated store using the barcode. In this case, the barcode should not be deleted during the process. Accordingly, in the following description, the operation in a state of the barcode not being deleted will be hereinafter described. A settlement request signal may be generated by the affiliated store smart device 200.

When the settlement request signal is generated, the affiliated store smart device 200 transmits the settlement request signal including the corresponding barcode and the purchase amount to the payment and settlement management server 300 (S345).

The payment and settlement management server 300, which has received the settlement request signal, transmits a signal for requesting settlement approval confirmation to the user smart device 100 (S347). At this time, the signal for requesting settlement approval confirmation may include information about the purchase amount, and affiliated store identification information. When the settlement request signal is transmitted in a state of including location information, the location information of the user who is a payer may be included.

The user smart device 100, which has received the signal for requesting payment and settlement approval confirmation, displays various pieces of information included in the signal for requesting payment and settlement approval confirmation and inspects whether or not the user inputs a payment and settlement approval command. At this time, when the user inputs the payment and settlement approval command, the user smart device 100 transmits the payment and settlement approval signal to the payment and settlement management server 300 (S349). If an approval refusal command is input, the user smart device 100 will transmit a payment and settlement refusal signal (not drawn) to the payment and settlement management server 300.

The payment and settlement management server 300 performs insolvency processing when receiving the payment and settlement refusal signal, and transmits the payment and settlement refusal signal to the affiliated store smart device 200 (not drawn). When the payment and settlement approval signal is received, the payment and settlement management server is connected to the corresponding financial server of the financial server unit 400 according to pre-registered payment information regarding the user so that actual settlement can be performed (S351).

When the payment and settlement are completed, the payment and settlement management server 300 stores the database for the details of payment and settlement 322, and deletes a barcode corresponding to the used barcode stored in the payment and settlement database 321 (S353).

After the barcode has been deleted, the barcode deletion requesting signal can be transmitted to each of the affiliated store smart device 200 and the user smart device 100 (S355, S357). When the barcode deletion requesting signal is received, the user smart device 100 and the affiliated store smart device 200 delete the barcode that has been stored for the payment and settlement service using the barcode.

FIG. 4 is a flow chart showing a method for payment and settlement using a barcode according to a second embodiment of the present invention. The method for payment and settlement using a barcode will be described with reference to FIGS. 1, 2, and 4.

In the sections regarding FIG. 3, the example in which the signal for requesting payment and settlement approval confirmation is transmitted to the user smart device 100 when actual payment and settlement are processed (S347), and processing of the payment and settlement is performed when the payment and settlement approval signal is input (S349) has been described.

However, in the sections of FIG. 4, the example in which payment and settlement is processed when a password for the barcode is set, and a settlement request signal including the password is received from the affiliated store smart device 200 has been described. In the description of FIG. 4, the same processes as that of FIG. 3 will be briefly described or omitted.

First, when the user drives the payment and settlement application using a barcode of the user smart device 100 (S411) and requests settlement by inputting a settlement amount and a password via the payment and settlement application using a barcode, the user smart device 100 transmits the settlement request signal including information about the password and the settlement amount to the payment and settlement management server 300 (S413).

The payment and settlement management server 300 determines whether or not payment can be performed by receiving the settlement request signal (S415, S417, S419). Then, the payment and settlement management server generates a barcode when the payment can be performed, and maps the password included in the settlement request signal with the generated barcode, thereby registering the mapped information in the payment and settlement database 321 (S421).

As described above, when the password is stored in a state of being mapped with the generated barcode, the payment and settlement management server 300 performs the processes of S423 to S443 as in FIG. 3.

After receiving and displaying the information about the details of settlement (S433), the affiliated store smart device 200 inspects whether or not the user inputs a password (S444).

When the password is input, the affiliated store smart device 200 transmits the settlement request signal including the password and the barcode input by the user to the payment and settlement management server 300 (S445). At this time, the barcode may be again scanned and input.

The payment and settlement management server 300, which has received the settlement request signal, detects the password from the settlement request signal and inspects whether or not the password is consistent with the registered password mapped with the barcode of the payment and settlement database 321 by comparing the passwords (S445).

When the registered password is consistent with the received password, the payment and settlement management server 300 is connected to the corresponding financial server of the financial server unit 400 based on the pre-registered settlement information regarding the user so that actual payment and settlement can be performed (S447).

After the actual payment and settlement has been performed, the payment and settlement management server deletes the barcode by conducting barcode deletion handling processes (S449, S451, S453).

While the present invention has been described with reference to the embodiments and accompanying drawings, it should be interpreted that terms or words used in the description and claims should not be interpreted as being limited merely to common and dictionary meanings but should be interpreted as having meanings and concepts which are defined within the technical scope of the present invention. Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A system for payment and settlement using a barcode, the system comprising:
a user smart device adapted to receive settlement amount information input via a settlement request means and to transmit a settlement request signal including the settlement amount information, user identification information, and device identification information, the user smart device receiving a barcode in response to the settlement request signal and storing and displaying the received barcode;
an affiliated store smart device adapted to scan the barcode from the user smart device and to transmit a settlement approval requesting signal including information about the scanned barcode, affiliated store identification information and purchase amount information, the affiliated store smart device receiving information about details of settlement including the settlement amount information of the barcode and the purchase amount information of a purchase product in response to the settlement approval request signal and storing and displaying the received information; and
a payment and settlement management server adapted to generate and register the barcode including the settlement amount information, user identification information, and device identification information included in the settlement request signal when receiving the settlement approval request signal from the user smart device and to transmit the generated barcode to the user smart device, the payment and settlement management server inspecting whether or not a barcode corresponding to the barcode included in the settlement approval request signal is registered when receiving the settlement approval request signal from the user smart device, and transmitting the details of settlement to the affiliated store smart device when a corresponsive barcode is registered.

2. The system of claim 1, wherein the payment and settlement management server checks whether or not a user has ability to pay a settlement amount included in the settlement request signal via a stored settlement means mapped with the user identification information when receiving the settlement request signal, thereby generating the barcode when the user has the ability to pay the settlement amount.

3. The system of claim 1, wherein the payment and settlement management server transmits information about the details of settlement to the affiliated store smart device and then deletes the registered barcode, thereby transmitting a barcode deletion requesting signal to the user smart device and the affiliated store smart device so that the barcode can be deleted.

4. The system of claim 1, wherein the payment and settlement management server registers information about a time at which the barcode is generated when registering the barcode and automatically deletes the barcode when the barcode issued to the user smart device is not used by a predetermined period from the time at which the barcode is generated, thereby transmitting a barcode deletion requesting signal to the user smart device and the affiliated store smart device so that the barcode can be deleted.

5. The system of claim 1, wherein the affiliated store smart device displays the details of settlement and then transmits a purchase amount payment requesting signal including the affiliated store identification information and the purchase amount and barcode information to the payment and settlement management server when a payment request for the purchase amount is generated,
the user smart device displays an approval confirmation signal received from the payment and settlement management server and generates an approval signal when an approval order is input by the user, thereby transmitting the generated approval signal to the payment and settlement management server, and
the payment and settlement management server transmits the approval confirmation signal resulting from a request for payment and settlement to the user smart device corresponding to the device identification information included in the barcode information when receiving the settlement request signal, the payment and settlement management server being connected to a financial server unit based on pre-registered settlement information regarding the user of the user identification information when receiving an approval signal from the user smart device in response to the approval confirmation signal so that payment and settlement can be performed.

6. The system of claim 1, wherein the user smart device further receives information about a password input from the user and transmits the information about the password by including the information in the settlement request signal, and
the payment and settlement management server maps and stores the password with the barcode when generating and registering the barcode by receiving the settlement request signal, the payment and settlement management server being connected to the financial server unit based on pre-registered settlement information regarding the user of the user identification information when a password for the barcode input from the affiliated store smart device after providing the details of settlement resulting from receiving the settlement approval requesting signal from the affiliated store smart is consistent with the barcode mapped with the barcode, so that payment and settlement can be performed.

7. The system of claim 5, wherein the payment and settlement management server deletes the registered barcode after processing the payment and settlement and transmits a barcode deletion requesting signal to the user smart device and the affiliated store smart device so that the barcode can be deleted.

8. The system of claim 5, wherein the payment and settlement management server registers information about a time at which the barcode is generated when registering the barcode, and automatically deletes the barcode when the barcode issued to the user smart device is not used by a predetermined period from the time at which the barcode is generated, the payment and settlement management server transmitting the barcode deletion requesting signal to the user smart device and the affiliated store smart device so that the barcode can be deleted.

9. A method for payment and settlement using a barcode, comprising:
receiving and storing, by a payment and settlement management server, user identification information and payment information of a user, and an affiliated store identification information and settlement information of an affiliated store, thereby registering the user and the affiliated store as members for payment and settlement services using a barcode;
transmitting, by a user smart device, a settlement request signal including settlement amount information, user identification information and device identification information to the payment and settlement management server, thereby requesting settlement;
generating and registering, by the payment and settlement management server, a barcode including settlement amount information, user identification information and device identification information included in the settlement request signal when receiving the settlement request signal from the user smart device, and transmitting the barcode to the user smart device, thereby providing the barcode;
scanning, by an affiliated store smart device, the barcode displayed on the user smart device, and transmitting a settlement approval requesting signal including the scanned barcode, affiliated store identification information, and purchase amount information to the payment and settlement management server, thereby requesting a settlement approval; and
inspecting, by the payment and settlement management server, whether or not the same barcode as the barcode included in the settlement approval signal is registered, and transmitting details of settlement to the affiliated store smart device when the barcode is registered.

10. The method of claim 9, wherein providing the barcode comprises: checking, by the payment and settlement management server, whether or not a user has to pay a settlement amount included in the settlement request signal via a stored settlement means mapped with the user identification information when receiving the settlement request signal; and generating the barcode when it is determined that the user has the ability to pay the settlement amount.

11. The method of claim 9, further comprising: deleting, by the payment and settlement management server, the barcode after providing the details of settlement; and transmitting a barcode deletion requesting signal to the user smart device and the affiliated store smart device so that the barcode can be deleted.

12. The method of claim 9, further comprising: registering, by the payment and settlement management server, information about a time at which the barcode is generated when receiving the barcode; automatically deleting the barcode when the barcode issued to the user smart device is not used by a predetermined period from the time at which the barcode is generated; and transmitting a barcode deletion requesting signal to the user smart device and the affiliated store smart device so that the barcode can be deleted.

13. The method of claim 9, further comprising: transmitting, by the affiliated store smart device, a purchase amount payment requesting signal including the affiliated store identification information, and purchase amount and barcode information to the payment and settlement management server when the affiliated store smart device displays the details of the settlement after the providing the details of the settlement, and a request for payment and settlement of the purchase amount is then generated;
transmitting, by the payment and settlement management server, an approval confirmation signal resulting from the request for the payment and settlement to the user smart device corresponding to the device identification information included in the barcode information when receiving the settlement request signal, thereby confirming a payment and settlement approval;
displaying, by the user smart device, the approval confirmation signal received from the payment and settlement management server and generating an approval signal when an approval order is input by the user, thereby transmitting the approval signal to the payment and settlement management server; and
connecting, by the payment and settlement management server, to a financial server unit based on pre-registered settlement information regarding the user of the user identification information when receiving the approval signal from the user smart device in response to the approval confirmation signal so that payment and settlement can be performed.

14. The method of claim 9, further comprising: transmitting, by the user smart device, a password input by the user during requesting of the settlement; mapping, by the payment and settlement server, the password with the barcode when generating and registering the barcode by receiving the settlement request signal; and connecting, by the payment and settlement server, to a financial server unit based on pre-registered settlement information regarding the user of the user identification information when a password for the barcode is input from the affiliated store smart device after the providing the details of the settlement, and the password is consistent with the password mapped with the barcode, so that payment and settlement can be performed.

15. The method of claim 13, further comprising: deleting, by the payment and settlement server, the registered barcode after processing the payment and settlement; and transmitting a barcode deletion requesting signal to the user smart device and the affiliated store smart device so that the one-time barcode can be deleted.

16. The method of claim 13, further comprising: registering, by the payment and settlement management server, information about a time at which the barcode is generated when registering the barcode during the providing the barcode; automatically deleting, by the payment and settlement management server, the barcode when the barcode issued to the user smart device is not used by a predetermined period from the time at which the barcode is generated; and transmitting the barcode deletion requesting signal to the user smart device and the affiliated store smart device so that the barcode can be deleted.
